(19) United States
(12) Patent Application Publication
(10) Pub. No.: US 2012/0022837 A1
(43) Pub. Date: Jan. 26, 2012

(54) Smoothing Of Stair-Stepped Geometry In Grids

(75) Inventors: Richard ASBURY, Abingdon (GB); Jonathan MORRIS, Oxford (GB)

(73) Assignee: SCHLUMBERGER TECHNOLOGY CORPORATION, Sugar Land, TX (US)

(21) Appl. No.: 13/006,269

(22) Filed: Jan. 13, 2011

Related U.S. Application Data
(60) Provisional application No. 61/345,931, filed on May 18, 2010.

(51) Int. Cl. G06F 17/10

(52) U.S. Cl. 703/2

(57) ABSTRACT

Smoothing stair-stepped geometry in grids is described. An example system modifies grid cells in a geologic grid model to convert a stair-stepped approximation of a geologic feature into a smooth representation of the geologic feature. The system determines approximately horizontal segments within a stair-stepped pattern that are intersected by the true surface of the geologic feature as defined by model data. The system then extends approximately vertical segments between intersected horizontal segments to the nearest cell boundaries. Cell nodes defining the endpoints of these extended vertical segments are then repositioned to the true surface of the geologic feature, while horizontal segments are collapsed. Pillars of the grid model are shifted in various beneficial ways to accommodate the repositioned nodes. The basic fabric and structure of a grid model is preserved while geologic features that are usually modeled with a stair-stepped approximation can be modeled as smooth lines in the grid model.

### RELATED APPLICATIONS

This patent application claims priority to U.S. Provisional Patent Application No. 61/345,931 to Asbury, entitled “Smoothing of Stair-Stepped Geometry in Grids,” filed May 18, 2010 and incorporated herein by reference in its entirety.

### BACKGROUND

A three-dimensional (3D) grid is often used to model a subsurface earth volume. The 3D grid model can subdivide a subsurface earth volume into a large number (typically millions) of small, bounded cells to model hydrocarbon reservoir geology, geomechanics, and fluid flow for a reservoir volume. Each cell can then be associated with information (often numerical) to create a spatially varying description of rock and fluid properties such as porosity, permeability, and pressure.

Reservoir grids used for such modeling often accommodate geological features such as faults, salt bodies and depositional surfaces (known as horizons) by ensuring that no grid cells cross the surfaces representing these features. Such grid models may use a system of upright, predominantly vertical pillars to define columns of grid cells, so that the cell edges can be moved and adapted to define some boundaries, rather than traverse them. These upright pillars are seldom exactly vertical, but can be considered approximately vertical in comparison to the horizontal cell tops and bottoms, which are approximately horizontal but usually not exactly horizontal. The horizontal cell tops and bottoms are often inclined to model the geological layering. In this manner, a grid model can adaptably represent many types of variable horizons and boundaries, without violating the inherent structure of the grid model itself. In this description, the pillars and columns will be referred to as vertical, which means “approximately and predominantly vertical” in comparison to cell tops and bottoms, which are “approximately and predominantly horizontal” in comparison with the pillars and columns. Pillars, however, can be defined in any direction as needed, but are often ideally defined to align with geological faults.

In such pillar grids, ensuring cell alignment can become complicated when the sub-surface contains many features with conflicting alignments. This is particularly common for faults, which often meet in opposing directions. In these cases, it can be difficult to generate pillars that reliably align to all faults. But the grid cells can still be used to model a complex feature by approximating edges of the feature with a “stair-step” pattern, which approximates the surface or edge. In a stair-stepped representation of a fault, for example, diagonal components of a surface or line are represented by stair-stepping the diagonal with the approximately vertical and approximately horizontal tops, bottoms, and sides of the model's grid cells. The stair-stepped geometry, however, distorts the modeled position of the actual fault for many operations, which can cause practical problems in modeling and actual exploration.

### SUMMARY

This disclosure describes smoothing of stair-stepped geometry in grids. An example system modifies grid cells in a geologic grid model to convert a stair-stepped approximation of a geologic feature into a smooth and authentic representation of the geologic feature. In one implementation, the system determines approximately horizontal segments within a stair-stepped pattern that are intersected by the true surface of the geologic feature as defined by model data. The system then extends approximately vertical segments between the intersected horizontal segments to the nearest cell boundaries. Cell nodes defining the endpoints of these extended vertical segments are then repositioned to the true surface of the geologic feature, while horizontal segments are collapsed. Pillars of the grid model are shifted in various beneficial ways to accommodate the repositioned nodes. The basic fabric and structure of a grid model is preserved while geologic features that are usually modeled with a stair-stepped approximation can be modeled as smooth surfaces and lines in the grid model.

This summary section is not intended to give a full description of smoothing of stair-stepped geometry in grids, or to provide a comprehensive list of features and elements. A detailed description with example implementations follows.

### BRIEF DESCRIPTION OF THE DRAWINGS

FIG. 1 is a diagram of an example grid modeling system that incorporates a smoothing engine.

FIG. 2 is a block diagram of an example computing environment for an example grid modeler that incorporates an example smoothing engine.

FIG. 3 is a block diagram of an example smoothing engine.

FIG. 4 is a diagram of a vertical cross-section of an example reservoir model operated on by the example grid modeler, showing a grid aligned with faults and horizons.

FIG. 5 is a diagram of example grid pillars defining cell columns in a grid model operated on by the example grid modeler.

FIG. 6 is a diagram of example node points defined along pillars to mark cell corners in a grid model operated on by the example grid modeler.

FIG. 7 is a diagram of an example 3D grid model operated on by the example grid modeler.

FIG. 8 is a diagram of an example cross-section of a sub-surface model operated on by the example grid modeler.

FIG. 9 is a diagram of an example grid produced by stair-stepping faults operated on by the example grid modeler.

FIG. 10 is a diagram of example pillar snapping and pillar shifting onto faults in the grid modeler.

FIG. 11 is a diagram of example cell corner adjustment to smoothly align a stair-stepped geometry to a fault surface.

FIG. 12 is a diagram showing determination of k-faces and panels in a stair-stepped representation of a fault in a grid.

FIG. 13 is a diagram showing panel extension during smoothing of a stair-stepped representation of a fault in a grid.

FIG. 14 is a diagram showing a technique for shifting a panel and nodes during smoothing of a stair-stepped representation of a fault in a grid.

FIG. 15 is a diagram showing pillar shifting during smoothing of a stair-stepped representation of a fault in a grid.

FIG. 16 is a diagram showing consequences of not performing panel extension during smoothing of a stair-stepped representation of a fault in a grid.

FIG. 17 is a diagram showing cell-to-cell volume smoothing by adjusting non-snapped nodes during smoothing of a stair-stepped representation of a fault in a grid.

FIG. 18 is a diagram showing smoothing of a lambda-fault configuration and adjustment of pillars by the example smoothing engine.

FIG. 19 is a diagram showing vertical subdivision of cells to control panel extension during smoothing of a stair-stepped representation of a y-fault in a grid.

FIG. 20 is a diagram showing grid refinement by increasing pillar resolution when faults meet along vertical intersection lines.

FIG. 21 is a flow diagram of an example method of smoothing a stair-stepped geometry in a grid.

FIG. 22 is a flow diagram of another example method of smoothing a stair-stepped geometry in a grid.

### DETAILED DESCRIPTION

Overview

This disclosure describes systems and methods for smoothing stair-stepped geometry in grids. In a subsurface modeling context, by allowing a geologic feature, such as a fault, to “step” through grid columns in a grid model, the stair-stepping relaxes a requirement to precisely align cell boundaries with input surfaces. The stair-stepping facilitates accurate representation of the displacement of geological layers across the fault, but at the expense of a geometric deformation of the fault surface itself in the grid. Faults will be used as examples of geologic features in the description below. Other geologic features, however, may be modeled and smoothed as described below, not just geologic faultsThe terms “vertical” and “vertically,” as used herein, mean approximately vertical, especially in comparison with approximately horizontal components. Likewise, the terms “horizontal” and “horizontally” mean approximately horizontal, especially in comparison with approximately vertical components.

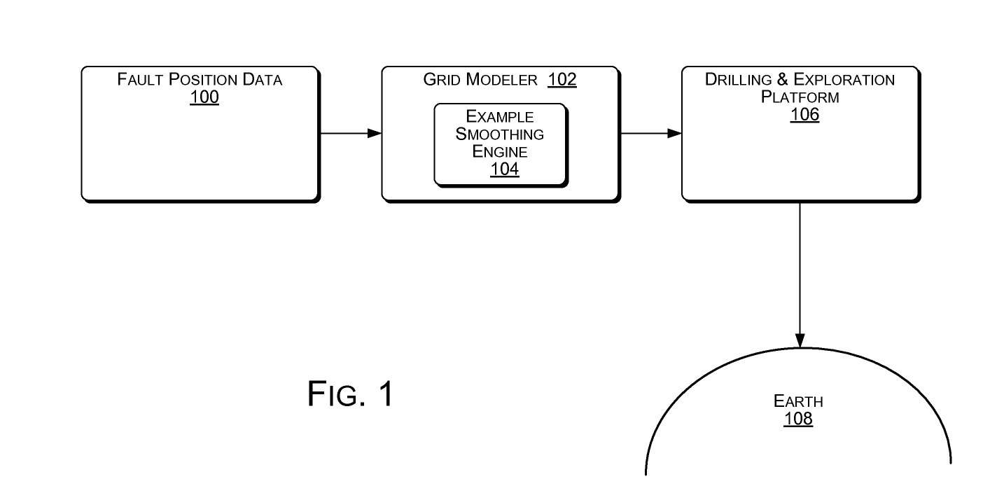

As shown in FIG. 1, while the trade-off between true fault position data 100 and a stair-stepped approximation of the fault as generated by a grid modeler 102 greatly broadens the ability of the grid modeler 102 to accommodate complex structure, the stair-stepped representation may introduce disadvantages in the subsequent practical and theoretical use of the grid. The example smoothing engine 104, to be described in greater detail below, “snaps” or smooths the stair-stepped geometry into a more faithful rendering of the fault position data 100, i.e., removes the stair-step artifact that was applied by the grid modeler 102 in modeling the fault position data 100. In one implementation, the example smoothing engine 104 does not smooth a stair-stepped geometry after the fact, but participates with the grid modeler 102 in creating an improved representation of the fault position data 100 from the outset.

When the example smoothing engine 104 has provided a smoothed representation of the fault position data 100, then actual wells drilled into a reservoir by drilling and exploration equipment 106 will intersect the true faults at correct depths in the earth 108. Sometimes, when using a conventional stair-stepped model of a fault, wells drilled into the reservoir intersect the true fault at slightly different depths than predicted by the stair-stepped faults, and in severe cases may have multiple spurious intersections with (or even be positioned on the wrong side of) the stair-stepped fault. This can result in errors when upscaling well logs and determining well completion intersections with the grid cells, which in turn invalidates the geological property modeling and flow simulation behavior. Similarly, mismatches in the relationship with other geometric information such as artificial fracture models and seismic data can interfere with modeling. The example smoothing engine 104 provides a solution to these discrepancies when stair-step modeling of features is used.

Example Environment

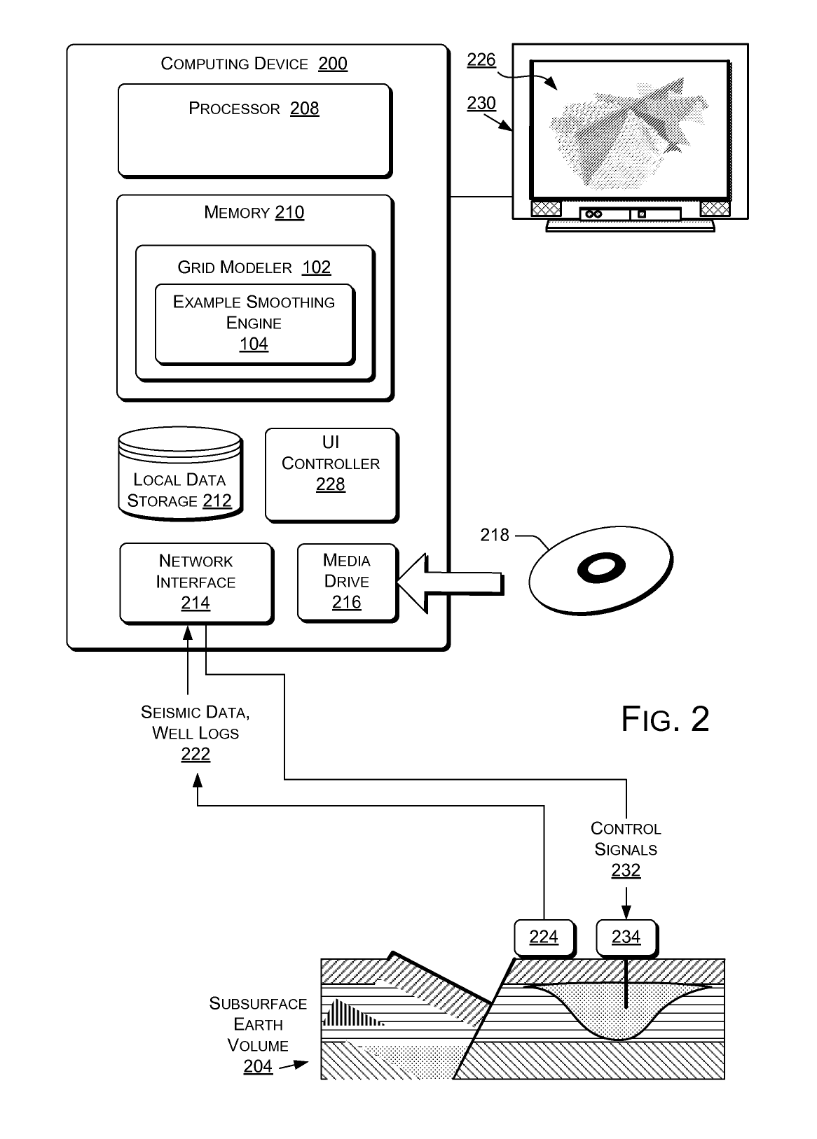

FIG. 2 shows an example system in which smoothing of stair-stepped geometry in grids can be performed. In this implementation, a computing device 200 implements a component, such as a grid modeler 102 that models a subsurface earth volume, e.g., a depositional basin, petroleum reservoir, seabed, etc. The grid modeler 102 is illustrated as software, but can be implemented as hardware or as a combination of hardware and software instructions.

In the illustrated example, the computing device 200 is communicatively coupled via sensory and control devices with a real-world setting, e.g., an actual subsurface earth volume 204, hydrocarbon reservoir, depositional basin, seabed, etc. The computing device 200 may also be in communication with wells for producing a petroleum resource, for water resource management, for carbon services, and so forth.

The computing device 200 may be a computer, computer network, or other device that has a processor 208, memory 210, data storage 212, and other associated hardware such as a network interface 214 and a media drive 216 for reading and writing a removable storage medium 218. The removable storage medium 218 may be, for example, a compact disk (CD); digital versatile disk/digital video disk (DVD); flash drive, etc.

In this example, the grid modeler 102 includes an example smoothing engine 104, either integrated as part of the fabric of the grid modeler 102; as a separate module in communication with the grid modeler 102; or as a retrofit module added on, for example, to an updated version of a given grid modeler 102.

The removable storage medium 218 may include instructions for implementing and executing the example smoothing engine 104. At least some parts of the example smoothing engine 104 can be stored as instructions on a given instance of the removable storage medium 218, removable device, or in local data storage 212, to be loaded into memory 210 for execution by the processor 208.

Although the illustrated example smoothing engine 104 is depicted as a program residing in memory 210, a smoothing engine 104 may be implemented as hardware, such as an application specific integrated circuit (ASIC) or as a combination of hardware and software.

In this example system, the computing device 200 receives field data, such as seismic data, well logs, etc., 222 from a device 224 in the field. The computing device 200 can receive the seismic data and well data 222 from the field via the network interface 214.

The computing device 200 may compute and compile modeling and control results, and a display controller 228 (user interface) may output geologic model images, such as a 2D or 3D grid model that uses stair-stepped geometry 226 on a display 230. The display controller 228 may also generate a visual user interface (UI) for input of user data. The displayed grid models 226 are based on the output of the grid modeler 102, including the example smoothing engine 104. The example smoothing engine 104 may perform other modeling and control operations and generate useful user interfaces via the display controller 228, including novel interactive graphics, for user control of smoothing stair-stepped geometries in grids.

The example smoothing engine 104 and grid modeler 102 may also generate or ultimately produce control signals 232 to be used via control devices, e.g., such as drilling and exploration equipment 106, in real-world control of a drilling and exploration operation 234, well systems, transport and delivery systems, and so forth.

Example Smoothing Engine

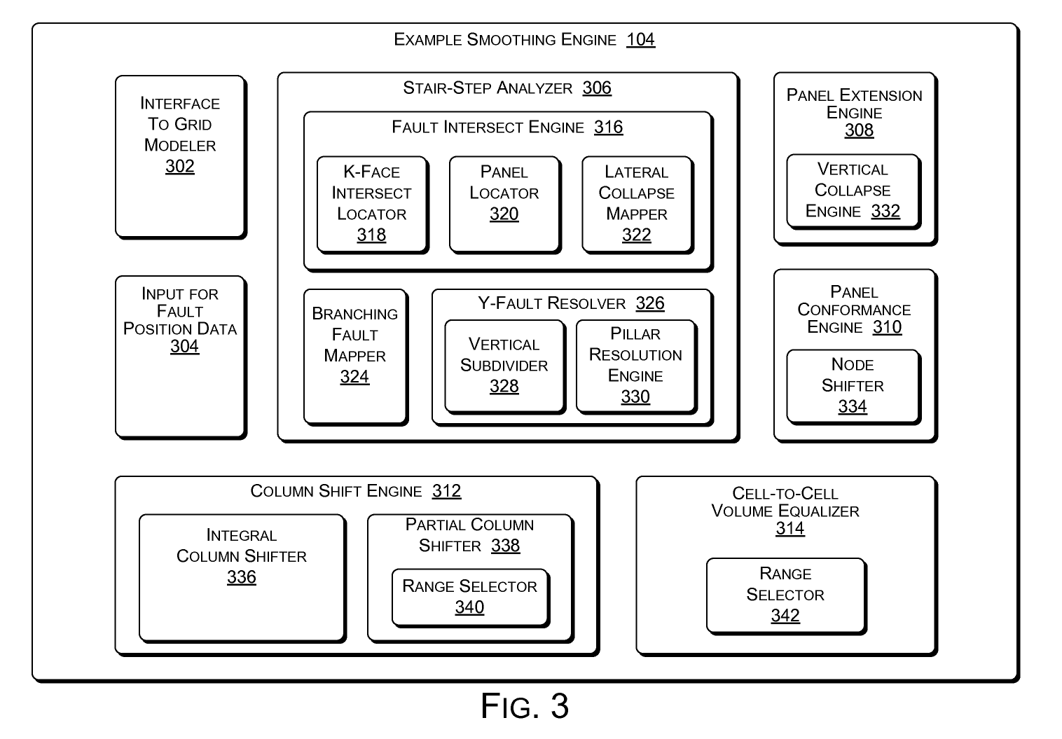

FIG. 3 shows an example smoothing engine 104 in greater detail than in FIG. 1 and FIG. 2. The illustrated implementation is only one example configuration for the sake of description, to introduce features and components of an engine that performs innovative smoothing of stair-stepped geometry in grid models. The illustrated components are only examples. Different configurations or combinations of components than those shown may be used to perform the smoothing functions, and different or additional components may also be used. Many other arrangements of the components and/or functions of an example smoothing engine 104 are possible within the scope of the subject matter. As introduced above, the example smoothing engine 104 can be implemented in hardware, or in combinations of hardware and software. Illustrated components are communicatively coupled with each other for communication as needed.

The illustrated example smoothing engine 104 in FIG. 3 includes example components, including an interface 302 to the grid modeler 102 (when needed), an input for fault position data 304 (when not available via the interface 302), a stair-step analyzer 306, a panel extension engine 308, a panel conformance engine 310, a column shift engine 312, and a cell-to-cell volume equalizer 314. The stair-step analyzer 306 may further include a fault intersect engine 316, including a k-face intersect locator 318, a panel locator 320, and a lateral collapse mapper 322. The stair-step analyzer 306 may also further include a branching fault mapper 324, and a y-fault resolver 326 that includes a vertical subdivider 328 and a pillar resolution engine 330. The panel extension engine 308 may further include a vertical collapse engine 332, while the panel conformance engine 310 may further include a node shifter 334. The column shift engine may further include an integral column shifter 336 and a partial column shifter 338 that includes a range selector 340. The cell-to-cell volume equalizer 314 may further include a range selector 342.

Operation of the Example Smoothing Engine

The example smoothing engine 104 may be integrated into the fabric of a grid modeler 102 or may exist as a discrete component and communicate with the grid modeler 102 via the interface 302. The grid modeler 102 generates or operates on a model of a subsurface earth volume 204, e.g., a reservoir model.

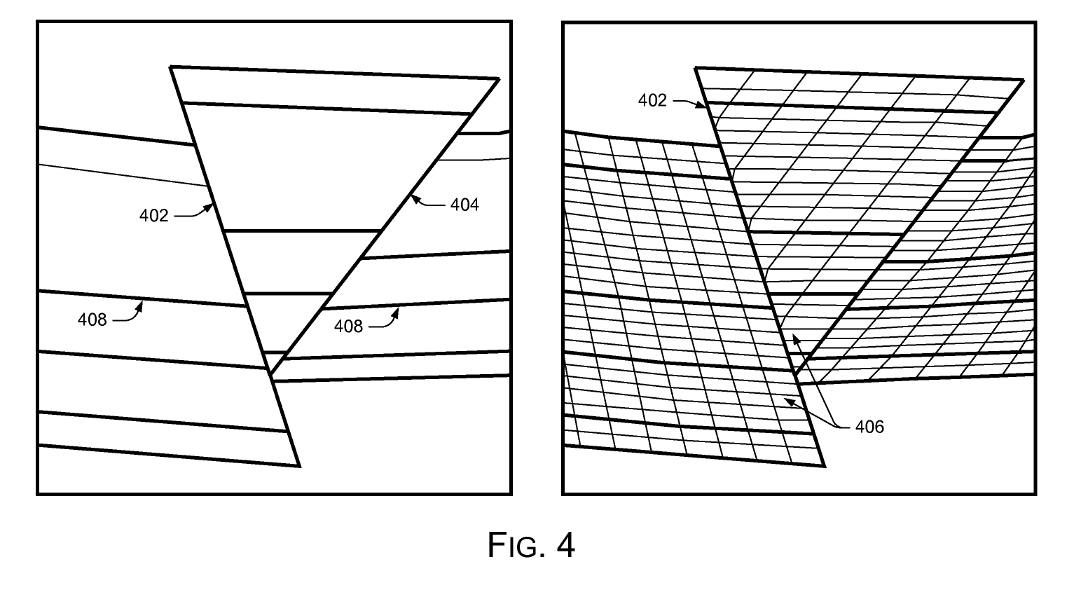

FIG. 4 shows a vertical cross section of a reservoir model showing features, such as faults 402 and 404. The grid cells 406 used for the modeling often accommodate geological features such as the faults 402 and 404, salt bodies, and depositional surfaces known as horizons 408, for example, by ensuring that no grid cells 406 cross the surfaces (or boundaries) of the features being modeled.

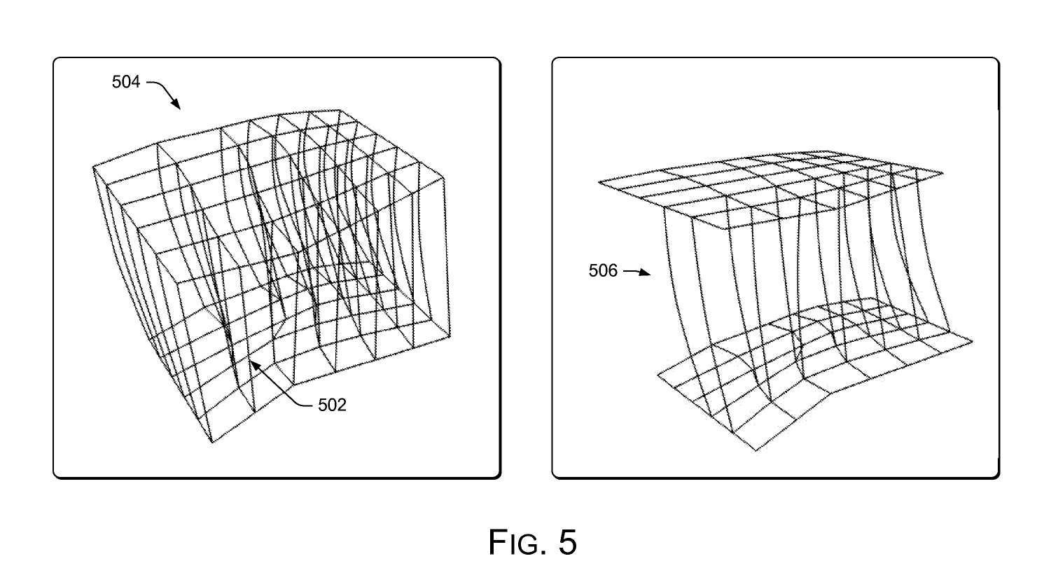

A grid modeler 102 typically applies a common technique used in geological gridding, known as “pillar gridding.” Pillar gridding can be applied to build a grid in two steps. First, as shown in FIG. 5, a set of upright, curvilinear uprights, such as pillars 502, are spread through the volume-of-interest 504. These pillars 502 define the corners of many columns of cells which may appear in the final grid. The columns of the grid do not necessarily have to be four-sided (i.e., have four corner pillars) rather, they can also have more complex unstructured connectivity and shapes. Similarly, pillars 502 do not necessarily have to be near-vertical or linear; pillars can be defined in any direction as needed, but are often ideally defined to align with geological faults. For illustration, the second panel of FIG. 5 shows a reduced set of pillars 506 delimiting six grid columns.

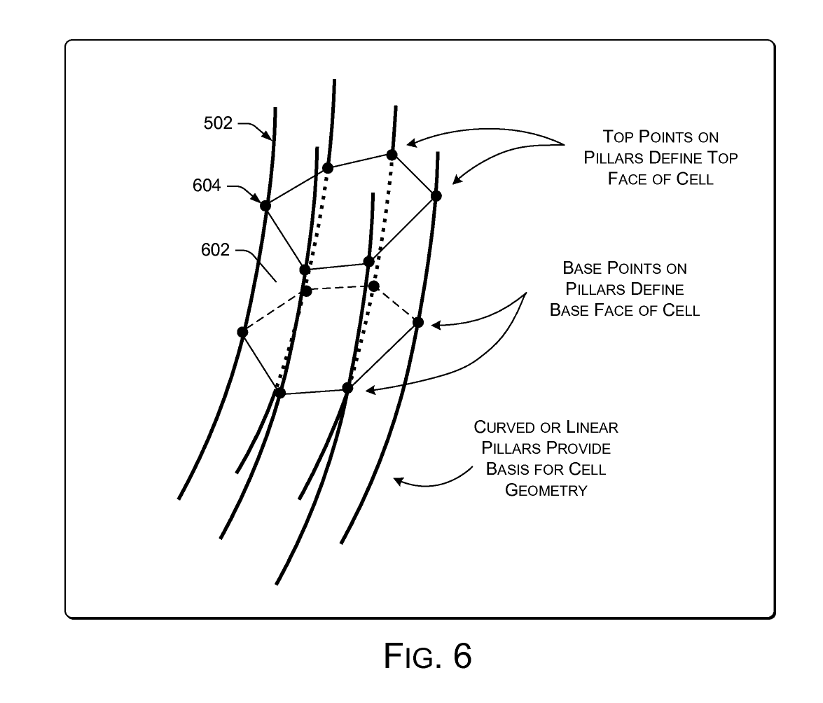

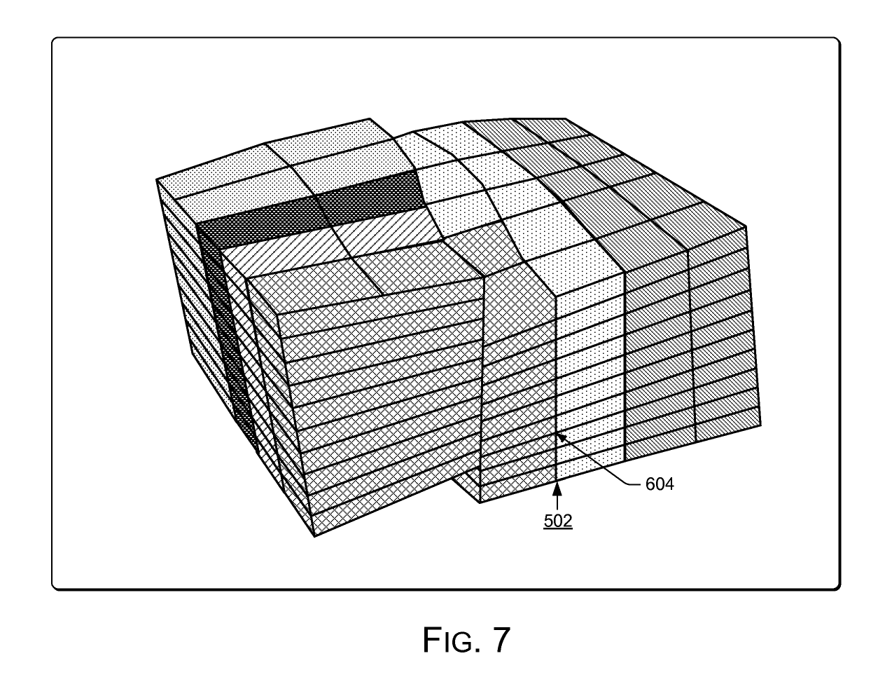

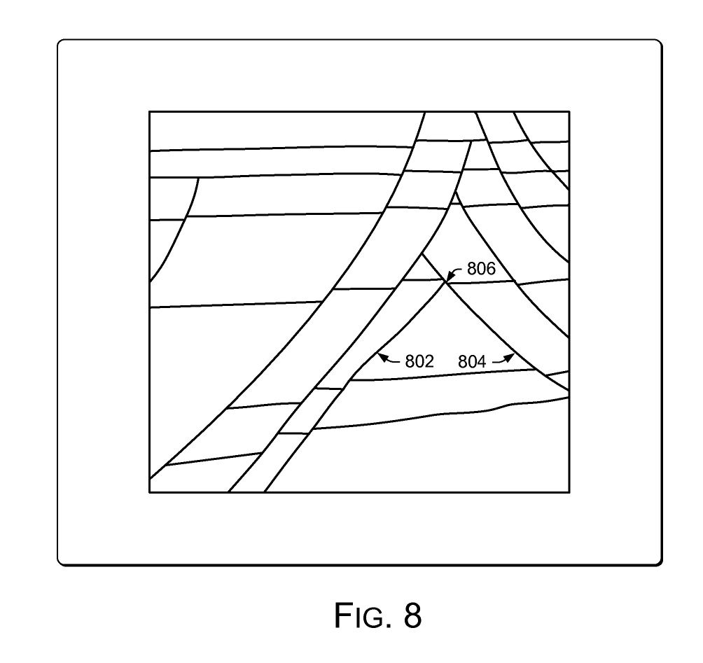

As shown in FIG. 6, once the pillars 502 have been defined, the columns can be subdivided into individual cells 602 by assigning points 604 along the pillars 502 to act as cell corners. In some cases, as shown in FIG. 7, neighboring columns may re-use the same points 604 on the pillars 502 that they share. In such pillar grids, the process of ensuring cell alignment can become complicated when the sub-surface contains many features with conflicting alignments. As shown in FIG. 8, this is particularly common for multiple faults 402, which often meet in opposing directions, such as fault 802 and fault 804, which meet in a lambda-configuration 806.

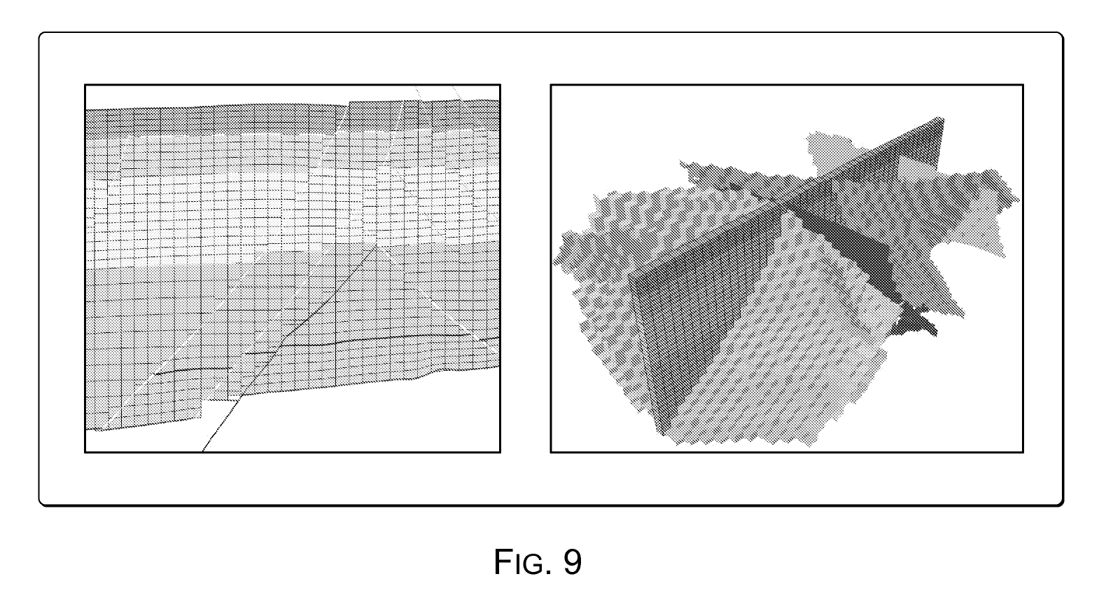

When alignment of the pillars and their cell edges with the faults and features being modeled becomes complicated, and it becomes difficult to generate pillars 502 that reliably align to all faults 402, the grid modeler 102 may “stair-step” some or all of the faults 402 instead. The grid modeler 102 then represents a fault 402 or other geologic feature as a stair-stepped approximation, in which diagonal components of a line are represented only by the more-or-less vertical and horizontal sides, tops, and bottoms of multiple grid cells 406. FIG. 9 shows a grid produced by stair-stepping faults, and a 3D slice of the grid shown with the stair-stepped faults.

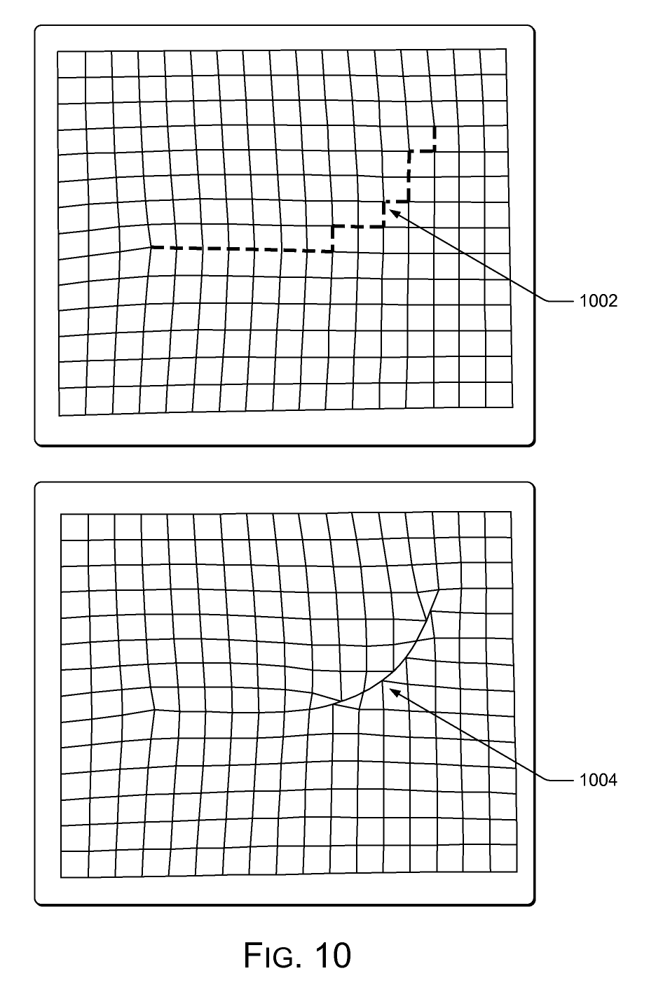

In one implementation, the grid modeler 102 uses both pillar gridding and stair-stepping to represent faults 402 or other geologic features. A number of software packages offer gridding functionality that is able to construct such stair-stepped grids. For example, SCHLUMBERGER's PETREL and FLOGRID systems both offer this capability (Schlumberger Ltd., Houston, Tex.). For example, as shown in FIG. 10, a technique of snapping pillars onto faults can be demonstrated in PETREL. An initial areal pillar grid can be generated onto which faults are digitized in a “zigzag” pattern 1002. All cells remain quadrilateral, but some have two sides that are near-parallel and so appear to be triangular. The underlying grid topology is not altered by this operation. This areal shifting of pillars 502 to create a snapped pillar 1004 to represent a fault 402 applies only if the pillars are fault-aligned to some degree, otherwise the grid modeler 102 represents a fault 402 with a stair-stepped geometry. But the stair-stepped geometry, although very versatile, distorts the modeled position of the actual fault or feature for many operations.

The example smoothing engine 104 can solve this distortion by repositioning cell nodes in the vicinity of a stair-stepped fault (or any other stair-stepped boundary) in order to flatten the grid's stair-step fault representation against the true fault surface 402 that has been input as fault position data 100 to the grid modeler 102.

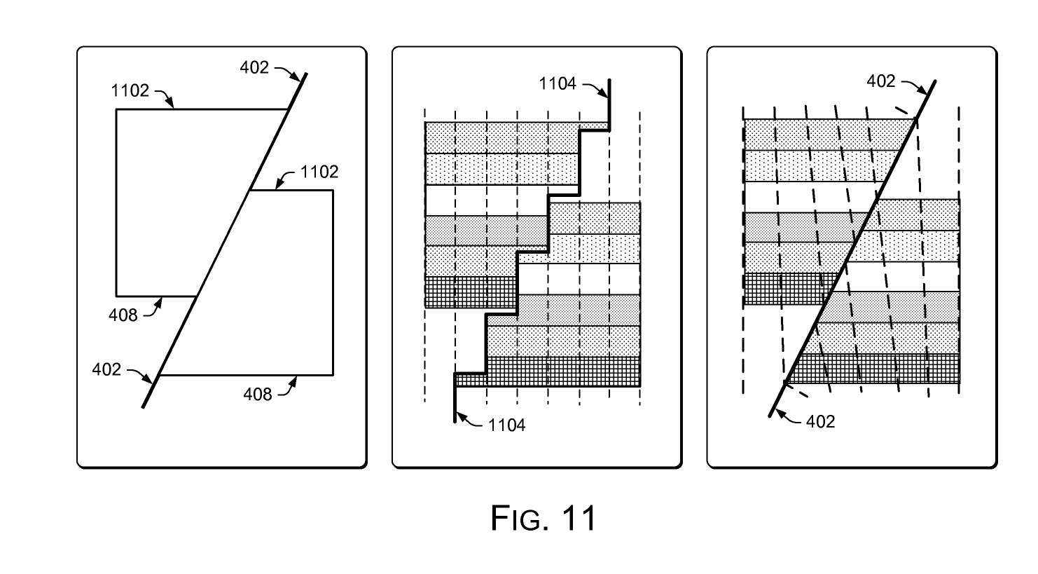

FIG. 11 shows a vertical cross section of a fault 402 and a pair of horizons, 408 and 1102, input as fault position data 100 to the grid modeler 102. A stair-stepped representation 1104 of the fault 402 is generated by the grid modeler 102. The example smoothing engine 104 adjusts cell corners near the fault 402 to smoothly align to the original fault surface 402. In the process, the column shift engine 312, a component of the example smoothing engine 104, shifts pillars to accommodate the cell nodes, moved to adjust the cell corners.

By accurately capturing the geometry of the fault surface 402 that was input as fault position data 100, the geometric relationship with other features such as wells and artificial fractures can be preserved more effectively. In addition, maintaining the capability to use stair-stepping—in addition to pillar alignment—to model surfaces and boundaries allows the grid modeler 102 to accommodate highly complex networks of interacting geological features. Thus, with the example smoothing engine 104 included, a grid modeler 102 is equipped to perform at least three significant modeling operations: alignment of pillars—pillar snapping—to represent some faults 402, stair-stepping to represent other faults 402 and features, and smoothing to increase the accuracy and resolution of the stair-stepped faults 1104.

The example smoothing engine 104 is not limited to grids with hexahedral (six-sided) cells; the example smoothing engine 104 can operate on any grid that has layering defined across a set of curvilinear pillars (any pillar grid—whether connectivity is structured or unstructured). In such grids, there is an unambiguous definition of column, and cell index within each column. The stair-step analyzer 306 component of the example smoothing engine 104 can operate on such grids, when the grid columns pass through a surface selected for stair-stepping.

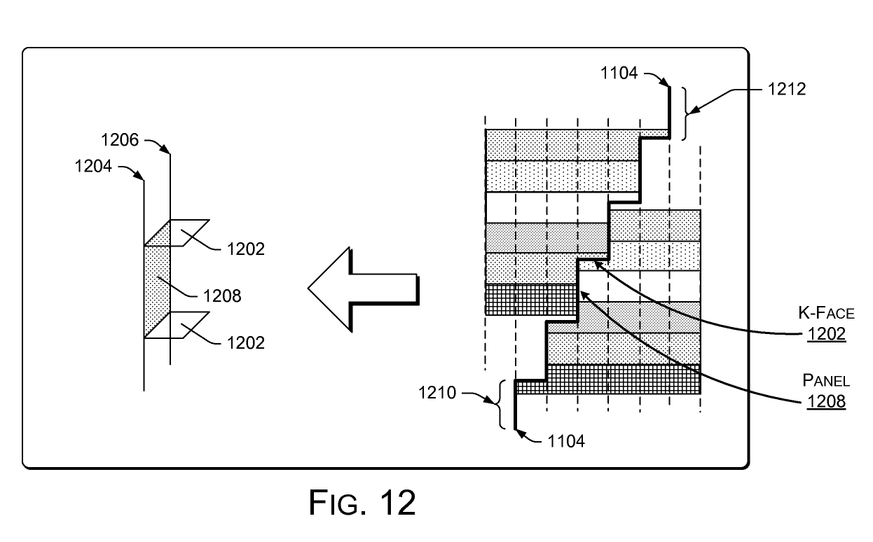

The fault intersect engine 316 locates the intersections between the fault 402 and the columns (or, intersection with a nearby cell top or base). As shown in FIG. 12, these horizontal cell tops or bases at or near the point of intersection with the true fault 402 are identified as “k-faces” 1202 of the stair-stepped fault 1104. Where two neighboring columns 1204 and 1206 have k-faces 1202 for the same stair-stepped fault 1104, the panel locator 320 joins a “panel” 1208 defined by the region delimited by the k-faces 1202 on the pair of pillars (1204 and 1206) shared between the two columns.

Panels 1208 may also exist without k-faces 1202 attached to their top or base; this is common around the vertical and lateral edges of the fault, for example panel 1210 and panel 1212 in FIG. 12.

In one implementation, to flatten the stair-stepped fault 1104 against the original fault surface 402, the k-face intersect locator 318 of the fault intersect engine 316 loops over the grid to find every k-face 1202. The lateral collapse engine 322 calculates in which direction each k-face 1202 will be collapsed. For structured grids, each k-face is collapsed in the I- or J-directions, or a combination of these.

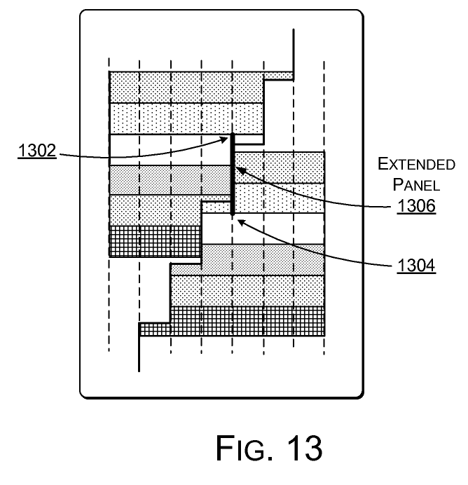

The panel locator 320 then iterates to find every panel 1208 in the stair-stepped fault 1104. As shown in FIG. 13, for each panel 1208, the panel extension engine 308 extends the panel 1208 upwards and downwards to touch (meet) the next cell corner along the respective pillar (i.e., when there is a gap in the grid between the panel 1208 and the next cell corner). That is, each panel 1208 is extended above to the next cell base 1302 and extended below to the next cell top 1304, i.e., above and below the original extent of the panel 1208, in order to make an extended panel 1306.

The panel conformance engine 310 shifts each cell corner (1302 and 1304) touching the extended panel 1306 to points on the fault surface 402, in directions indicated by the k-faces 1202 at the top and base of the extended panel 1306 (if they exist). In other words, the panel conformance engine 310 with its node shifter 334 performs the core smoothing or “snapping” operation of the example smoothing engine 104, in which the panels 1208 of the stair-stepped fault 1104 are moved or “snapped” onto the surface of the true fault 402 as given by the fault position data 100 input to the example smoothing engine 104. The node shifter 334 may select these points in various ways, but shifting these cell corners ideally avoids changing the layer inclination near the fault 402.

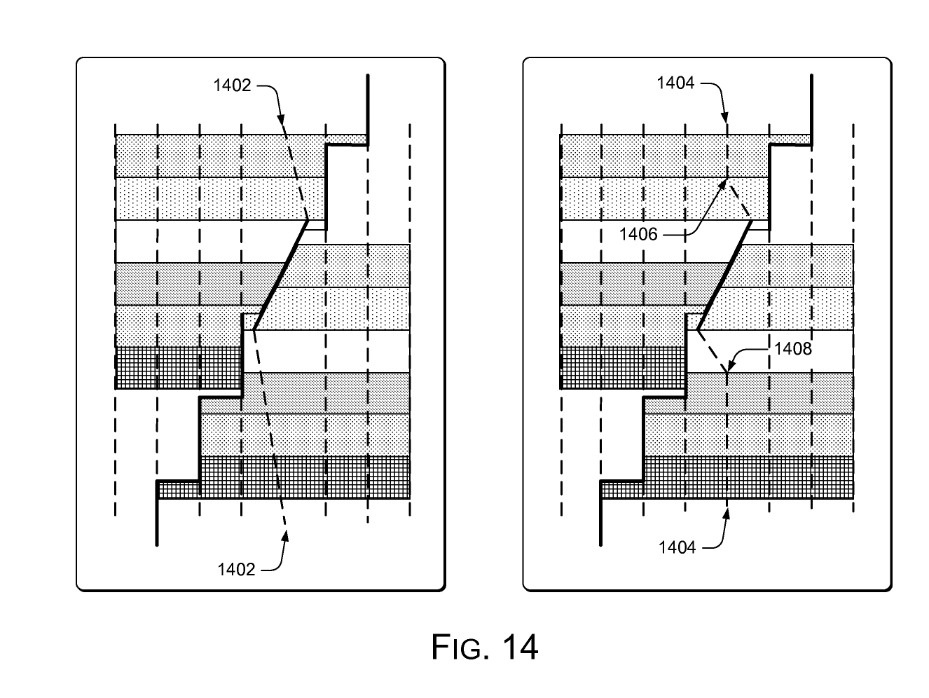

FIG. 14 shows the process of shifting the extended panel 1306 onto the true fault surface 402. Optionally, other points on the corresponding pillars can also be shifted in various ways. In one implementation, the column shift engine 312 includes an integral column shifter 336 that linearly shifts an entire pillar 1402 above and below the fault 402, as shown on the left in FIG. 14. The column shift engine 312 may also include a partial column shifter 338 and a range selector 340 that shifts each involved pillar 1404 so that the pillar 1404 is angled only from the point of the next cell boundary above 1406 and cell boundary below 1408 the fault 402 (or is angled to cell boundaries that are a number of cells away from the fault 402, as selected by the range selector 340). This alternate approach is shown on the right in FIG. 14.

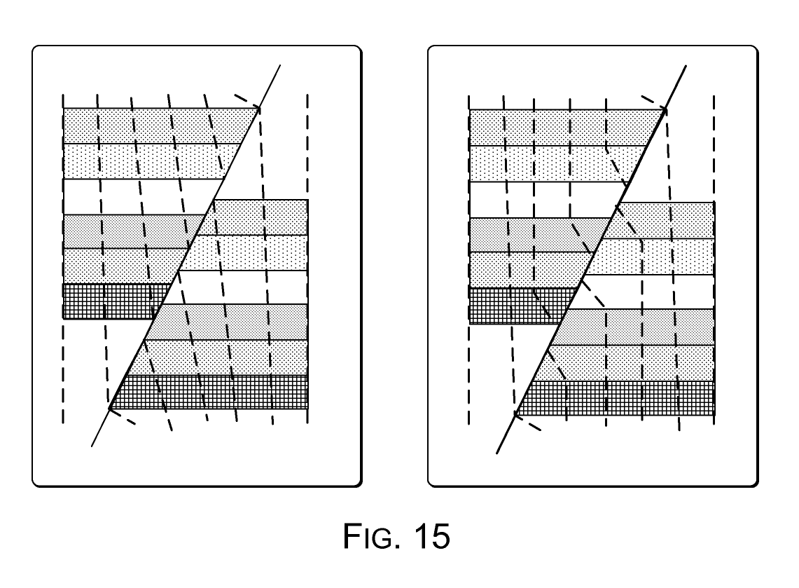

Once the node shifter 334 of the panel conformance engine 310 has moved the endpoints of each extended panel 1306 associated with the stair-stepped fault 1104, there will be a smooth representation of the fault 402 in the grid. FIG. 15 shows two results, in which the stair-stepped fault 1104 has been smoothed to create fully fault-aligned grids. In both grids, the stair-stepped fault panels 1306 have been aligned to the true fault 402. The left side of FIG. 15 shows the pillars linearly shifted in their entirety above and below the fault 402. The right side of FIG. 15 shows the pillars shifted only for the cells above and below the panels 1306.

Due to the extension of the panels 1306 (see FIG. 13), which is necessary to maintain, for example, hexahedral cell geometry, some cells directly above or below the fault k-faces 1202 will be laterally collapsed. When this occurs in a diagonal direction, the collapse of the cells may introduce unusual connections in the grid. For example, in a structured grid, some cell I-faces on one side of the fault 402 may connect to the J-face of another cell on the other side of the fault 402. In some circumstances, the vertical collapse engine 332 can vertically collapse such cells before the snapping operation, and can make associated adjustments to neighboring cells. This can eliminate the need for the panel 1208 to be extended at all.

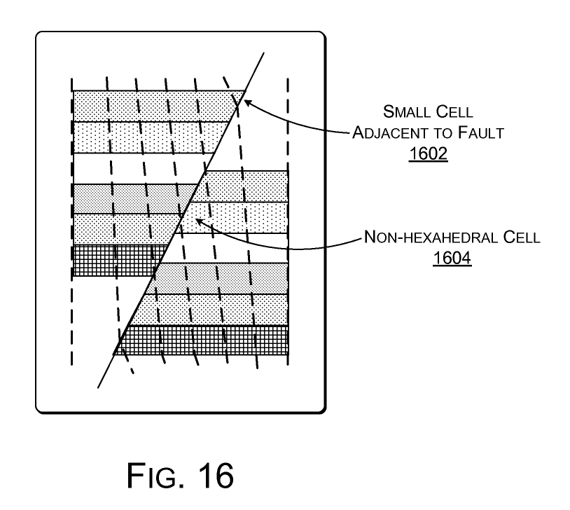

Otherwise, when not using the vertical collapse engine 332, the step of extending the panels 1208 performed by the panel extension engine 308 causes thin cells above and below the k-faces 1202 in the stair-stepped grid 1104 to be laterally collapsed. As shown in FIG. 16, when the panel extension engine 308 does not extend the panels 1208, and the vertical collapse engine 332 has not vertically collapsed the cells that will be laterally collapsed, then the resulting grid may include small cells 1602 next to the fault 402, and in addition, some adjacent cells 1604 will not be hexahedral, or will not be the current geometry of the grid cells in use. So, extending the panels 1208 to create extended panels 1306 prevents these undesirable consequences.

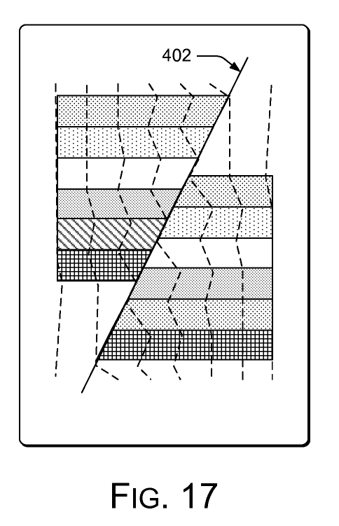

In one implementation, the cell-to-cell volume equalizer 314 can also smooth some cell corners which are not directly affected by the main snapping or smoothing of the fault 402, based on nearby cell corners. FIG. 17 shows shifting of some non-snapped grid nodes to smooth cell-to-cell volumes. This shifting of nodes appears as an adjustment of the pillars near the fault 402 in FIG. 17. There are a number of ways to accomplish this, including a distance-based shift along the grid layers as selected by the range selector 342 of the cell-to-cell volume equalizer 314. This homogenization of the cell volumes and of the cell sizes and shapes by redistributing the non-snapped nodes in the vicinity of the modeled fault 402 can have some beneficial effects. For example, reducing the discrepancy in cell volumes between adjacent cells near to the fault 402 can help when simulating dynamic behavior (e.g., geomechanics or fluid flow).

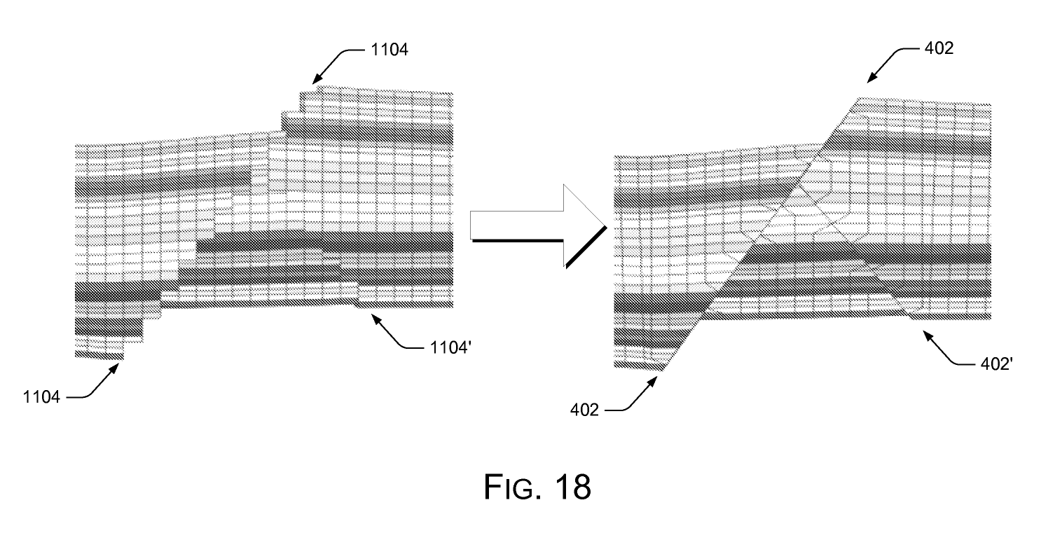

FIG. 18 (left) shows stair-stepped faults 1104 and 1104′, a lambda-fault configuration, and in FIG. 18 (right) final results of snapping, the shown representations smoothed to the true faults 402 and 402′, with the pillars shifted only for the cells above and below the panels 1306.

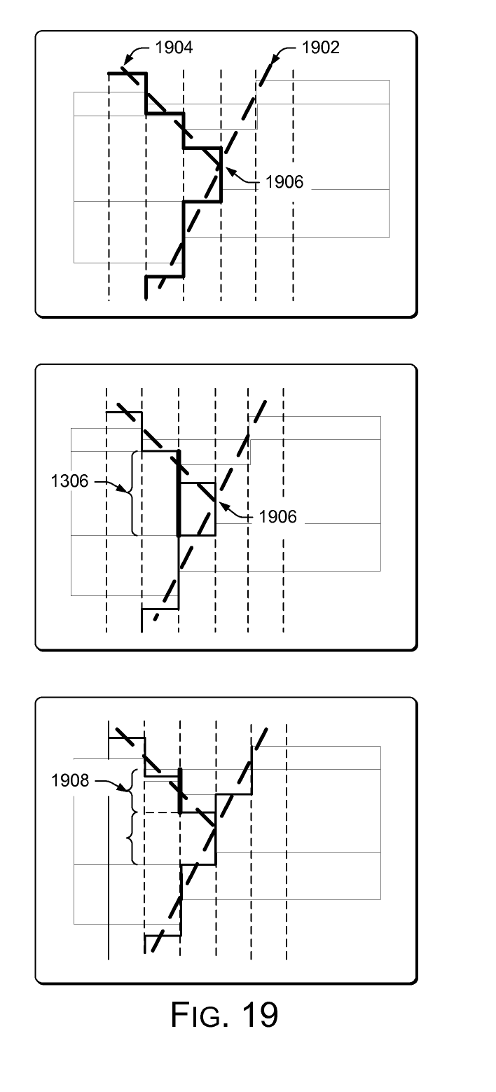

The stair-step analyzer 306 may include a branching fault mapper 324 to track intersected faults in the fault position data 100. FIG. 19 (top) shows part of a grid in which intersected faults 1902 and 1904 meet to from an intersection 1906 along roughly horizontal intersection lines (e.g., y-faults). The y-fault resolver 326 includes a vertical subdivider 328 to resolve difficulties caused by panel extension during the process of smoothing/snapping the faults 1902 and 1904 to the grid. Sometimes, as shown in FIG. 18 (middle), panel extension that extends vertically above and below the intersection 1906 produces ambiguity regarding which fault the extended panel 1306 should model. The vertical subdivider 328 therefore generates subdivided grid cells 1908 neighboring the intersection to limit an extension of each extended panel 1306 to a corresponding fault or corresponding geologic feature.

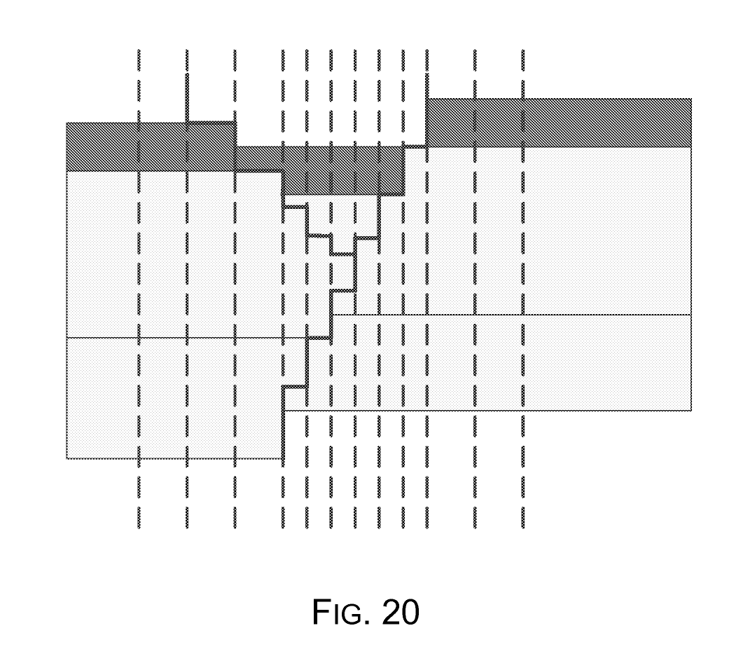

Similarly, as shown in FIG. 20, areal grid refinement can improve smoothing/snapping accuracy where faults meet along vertical intersection lines. The pillar resolution engine 330 can adjust grid pillars so that cells not directly touching the fault 402 are also modified. This can be exploited to achieve a smoother transition of cell geometry and volumes in the vicinity of the fault 402. Refinement of the grid in a particular region can be used to better distinguish connected faults, and so improve smoothing/snapping accuracy.

Example Methods

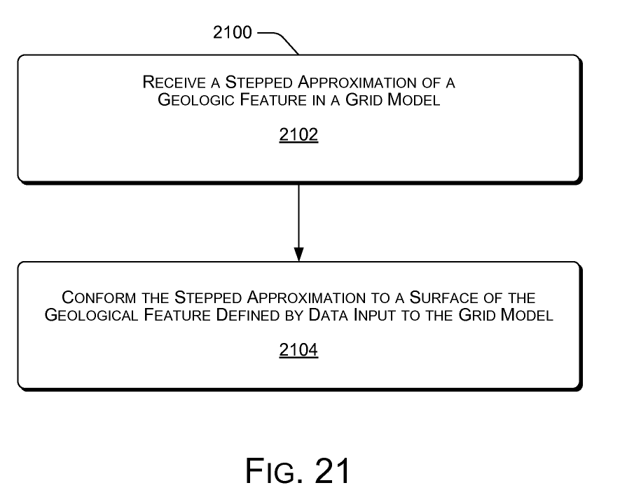

FIG. 21 shows an example method 2100 of smoothing stair-stepped geometry in a grid. In the flow diagram, the operations are summarized in individual blocks. The example method 2100 may be performed by hardware or combinations of hardware and software, for example, by the example smoothing engine 104.

At block 2102, a stepped approximation of a geologic feature in a grid model is received.

At block 2104, the stepped approximation is conformed to a surface of the geologic feature defined by data input to the grid model.

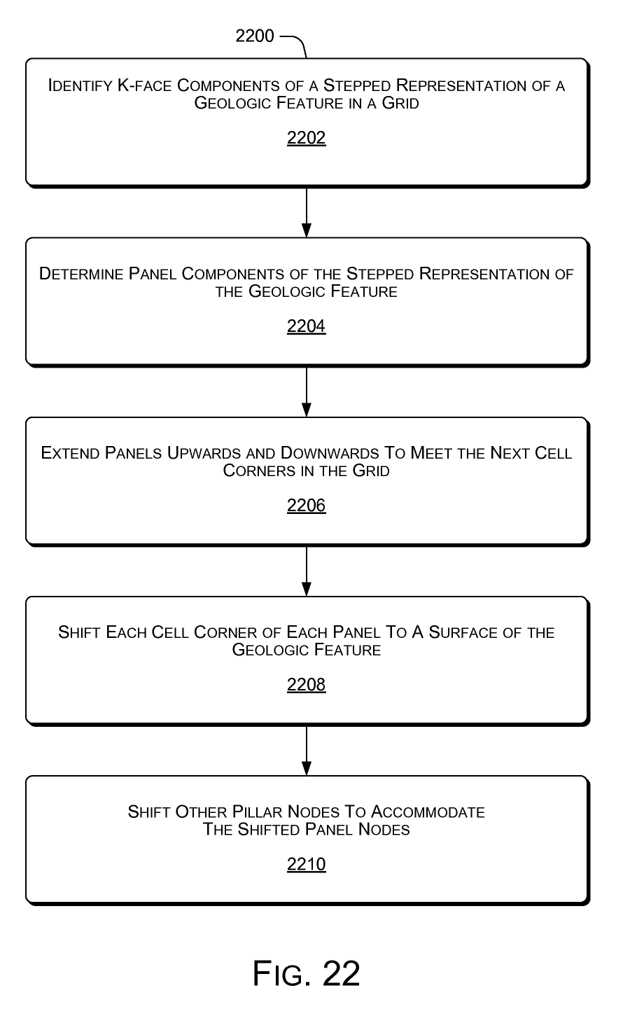

FIG. 22 shows an example method 2200 of smoothing a stepped geometry in a grid. In the flow diagram, the operations are summarized in individual blocks. The example method 2200 may be performed by hardware or combinations of hardware and software, for example, by the example smoothing engine 104.

At block 2202, k-face components of a stepped representation of a geologic feature in a grid are identified.

At block 2204, panel components of the stepped representation of the geologic feature are determined.

At block 2206, the panel components are extended upwards and downwards to meet the next cell corners in the grid. Due to the extension of the panel components (which is necessary to maintain cell geometry) some cells directly above or below the fault k-faces can be laterally collapsed.

At block 2208, each cell corner touching the panel is shifted to a true surface of the geologic feature. In other words, each panel component is “rotated” onto the known true surface of the fault or geologic feature.

At block 2210, pillar nodes not touching the panel component may be shifted to accommodate the shifted cell corners. That is, other points on the pillars associated with the extended panel components can optionally be shifted to advantage in various ways. Once all of the extended panel components have been brought into alignment with the true fault surface, there is a smooth representation of the fault in the grid.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A computer-executable method, comprising:
receiving a stepped approximation of a geologic feature in a grid model; and
conforming the stepped approximation to a surface of the geologic feature defined by data input to the grid model.

2. The computer-executable method of claim 1, wherein the geologic feature comprises a fault.

3. The computer-executable method of claim 1, wherein the grid model comprises a 3-dimensional model.

4. The computer-executable method of claim 1, further comprising:
determining approximately horizontal segments of the stepped approximation intersected by the surface of the geologic feature defined by the data;
determining an approximately vertical segment of the stepped approximation between two of the intersected approximately horizontal segments; and
shifting the vertical segment to conform to the surface of the geologic feature defined by the data while collapsing the approximately horizontal segments.

5. The computer-executable method of claim 4, further comprising:
extending a top of the vertical segment to the next higher adjacent cell boundary in the grid model;
extending a bottom of the vertical segment to the next lower adjacent cell boundary in the grid model;
moving nodes defining the top and bottom of the vertical segment onto the surface of the geologic feature defined by the data to shift the vertical segment; and
shifting columns of the grid model to accommodate the moved nodes.

6. The computer-executable method of claim 5, further comprising shifting each column containing a moved node over an entire length of the column.

7. The computer-executable method of claim 5, further comprising shifting only a segment of each column containing a moved node, wherein the size of the segment to be shifted is defined by selecting a number of grid cells defining a distance from the surface of the geologic feature.

8. The computer-executable method of claim 5, further comprising laterally collapsing grid cells to accommodate extending the vertical segment.

9. The computer-executable method of claim 5, further comprising shifting columns not containing a moved node to equalize grid cell volumes over a selected number of grid cells defining a distance from the surface of the geologic feature.

10. The computer-executable method of claim 5, further comprising one of:
when two geologic features meet at an intersection in the grid model, then vertically subdividing grid cells neighboring the intersection to limit an extension of each vertical segment to a corresponding geologic feature; or
when two geologic features meet at a substantially vertical intersection line, then applying an areal grid refinement to improve a snapping accuracy.

11. A computer-readable storage medium, containing instructions, which when executed by a computer perform a process for smoothing a stair-stepped geometry representing a geologic feature in a grid model, comprising:
receiving a true boundary surface of the geologic feature input as data to the grid model; and
repositioning cell nodes in a vicinity of a stair-stepped boundary in the model to flatten the stair-stepped geometry against the true boundary surface input as data to the grid model.

12. The computer-readable storage medium of claim 11, further including instructions for shifting columns of the grid model to accommodate the repositioned cell nodes.

13. The computer-readable storage medium of claim 12, further including instructions for shifting the columns by shifting columnar edges of individual grid cells within a distance from the true boundary to average a volume of each grid cell within the distance.

14. The computer-readable storage medium of claim 11, further comprising instructions for:
determining approximately horizontal segments of the stair-stepped geometry intersected by the true boundary surface of the geologic feature;
determining an approximately vertical segment of the stair-stepped geometry between two of the intersected approximately horizontal segments;
repositioning cell nodes corresponding to the endpoints of the vertical segment onto the true boundary surface; and
collapsing the approximately horizontal segments to accommodate repositioning the cell nodes of the vertical segment.

15. The computer-readable storage medium of claim 14, further comprising instructions for:
extending a top of the vertical segment to the next higher adjacent cell boundary in the grid model;
extending a bottom of the vertical segment to the next lower adjacent cell boundary in the grid model; and
repositioning cell nodes corresponding to the endpoints of the extended vertical segment onto the true boundary surface.

16. The computer-readable storage medium of claim 14, further comprising instructions for performing one of:
vertically subdividing grid cells in a vicinity of an intersection of two true boundaries in the grid model to limit the extending of each vertical segment to a corresponding true boundary; or
when boundaries of two geologic features meet at a substantially vertical intersection line, then applying an areal grid refinement to improve a snapping accuracy.

17. A computer-readable storage medium, containing instructions, which when executed by a computer perform a process, comprising:
receiving a surface of a geologic feature input as data to a grid model;
modifying grid cells in the grid model to convert a stair-stepped representation of the surface of the geologic feature into a smooth representation of the surface of the geologic feature.

18. The computer-readable storage medium of claim 17, further containing instructions for:
determining approximately horizontal segments of the stair-stepped representation that are intersected by the surface of the geologic feature defined by the data;
determining an approximately vertical segment of the stair-stepped representation between two of the intersected approximately horizontal segments; and
relocating nodes representing endpoints of the vertical segment onto the surface of the geologic feature defined by the data.

19. The computer-readable storage medium of claim 18, further containing instructions for:
extending a top of the vertical segment to a higher cell boundary in the grid model;
extending a bottom of the vertical segment to a lower cell boundary in the grid model; and
relocating nodes representing endpoints of the extended vertical segment onto the surface of the geologic feature defined by the data.

20. The computer-readable storage medium of claim 19, further containing instructions for shifting columns of the grid model to accommodate the relocated nodes.
